(19) United States
(12) Patent Application Publication
(10) Pub. No.: US 2026/0111038 A1
(43) Pub. Date: Apr. 23, 2026

(54) LOAD UNIT, CONCATENATION, AND METHOD FOR OPERATING MOBILE LOAD UNITS

(71) Applicant: Volkswagen Aktiengesellschaft, Wolfsburg (DE)

(72) Inventors: Daniel SCHUETZ, Wolfsburg (DE); Frank PETERSHAGEN, Wolfsburg (DE)

(73) Assignee: Volkswagen Aktiengesellschaft, Wolfsburg (DE)

(21) Appl. No.: 19/361,715

(22) Filed: Oct. 17, 2025

(30) Foreign Application Priority Data
Oct. 17, 2024 (DE) 10 2024 210 062.5

(51) Int. Cl. G05D 1/667; B60D 1/01; B60L 50/60; B62D 63/02; G05D 1/695

(52) U.S. Cl. CPC G05D 1/667; B60D 1/01; B60L 50/60; B62D 63/02; G05D 1/696

(57) ABSTRACT

A mobile load unit is provided that is configured to receive at least one cargo and to transport it on a drivable surface. At least one electric drive for driving wheels of the load unit is provided. At least one battery provides electrical energy for the drive, which permits a technologically simple and cost-efficient transport of cargoes. The load unit is equipped with at least one control unit having a sensor system for the automated or autonomous control of the load unit during a slow travel.

This nonprovisional application claims priority under 35 U.S.C. § 119(a) to German Patent Application No. 10 2024 210 062.5, which was filed in Germany on Oct. 17, 2024, and which is herein incorporated by reference.

### BACKGROUND OF THE INVENTION

### Field of the Invention

The invention relates to a mobile load unit, which is configured to receive at least one cargo and to transport it on a drivable surface, comprising at least one electric drive for driving wheels of the load unit and comprising at least one battery for providing electrical energy for the drive, the load unit including at least one control unit having a sensor system for the automated control of the load unit. The invention furthermore relates to a concatenation of multiple load units and a method for operating load units.

### Description of the Background Art

In the area of land-based transportation, many improvements and optimizations are possible due to automation. For example, the increasing shortage of qualified drivers for trucks may be compensated for by autonomously operated transport vehicles.

A problematic aspect of approaches known up to now for the autonomous transport of large goods and containers is the need for manually performed reloading processes and intermediate storage, which may prevent a full automation of the transport process. These processes require a large amount of space for maneuvering and intermediate storage of the cargoes. The known approaches do not have a complete view of the transport process but concentrate on individual sections of the transport process. For example, DE 10 2017 011 995 A1 describes a piece of transport equipment for transporting a load carrier as well as a method for operating a piece of transport equipment. Each piece of transport equipment includes a drive unit and may be coupled with other pieces of transport equipment to form a concatenation. The particular pieces of transport equipment are autonomously operated in the concatenation or independently of each other. Each of these pieces of transport equipment requires a cost-intensive sensor system and control technology for implementing driving tasks in the public traffic area and maneuvering tasks at low speed.

### SUMMARY OF THE INVENTION

It is therefore an object of the present invention to provide a load unit, a concatenation of multiple load units, and a method for operating load units, which permit a technologically simple and cost-efficient transport of cargoes.

According to an example of the invention, a load unit is provided, which is configured to receive at least one cargo and to transport it on a drivable surface. For this purpose, the load unit comprises at least one electric drive for driving wheels of the load unit and at least one battery for providing electrical energy for the drive. The load unit may have three or more wheels to receive the load of the cargo and to distribute it on the road or a surface. The load unit includes at least one control unit having a sensor system for the automated control of the load unit. The control unit and the sensor system are advantageously configured to control the load unit autonomously during a slow travel.

The load unit may be controlled autonomously within protected areas, such as hubs, port facilities, logistics centers, truck stops, and the like. In addition to the autonomous calculation of the control by the control unit of the load unit, a central routing of the load unit may also be provided. Areas of this type are particularly optimally suitable for autonomous driving at low speeds or during slow travel.

Due to the design of the sensor system and the control unit of the load unit for the slow travel, a cost-intensive technology of an autonomous driving (AD) system for higher speeds may be dispensed with. The load unit may be provided with a particularly cost-efficient and technologically simple design.

A slow travel may be, for example, a maneuvering travel or a general movement of the load unit on the surface at speeds of less than 20 km/h. Load units may be automated by means of the slow travel, for example picking up a cargo or delivering the cargo or changing their formation or being grouped or sorted and the like, depending on a destination or place of delivery of the cargo. An autonomous parking or placement of the load unit may also take place by means of the slow travel.

The control unit of the load unit may be managed, for example, by a central cloud routing or at least receive instructions from a central cloud routing.

The load unit may advantageously be supplied with electrical energy in an automated manner for the purpose of charging the at least one battery.

The drive and the wheels of the load unit may be designed as a platform or as a chassis, which may be used in a modular manner. The control unit, the sensor system, and the battery may thus be replaceable and/or expandable in a technologically simple manner.

The load unit may be used in a particularly versatile manner and be cost-efficiently maintained if the load unit has a permanently installed or replaceable battery.

The load unit can be configured to receive and transport a cargo in the form of a container and/or a crate and/or a receiving container having bulk materials and/or a container filled with fluids. This enables the load unit to transport standardized cargoes or those which deviate from customary regulations. A container may be designed, for example, as an overseas container.

The cargo is advantageously positioned in the load unit in a lockable manner, so that an unloading of the autonomously acting load unit during transport is avoided.

The load unit may be technologically particularly easily coupled with other load units, if it has, for example, at least one interface arranged on the end side in the direction of travel. The interface is configured to receive mechanical loads and to send and/or receive data. The load unit may have, for example, a first interface arranged on a front and a second interface arranged on the back. Due to this measure, multiple load units may be mechanically coupled to form a concatenation, which may travel a route or a route section as a combination or platoon.

The interface may be designed, for example, as a lockable plug connection. The load units are configured to autonomously take a position relative to each other, from which an automated coupling with the aid of the interfaces is implemented.

The interface can be configured to receive electrical energy for charging the battery and/or for supplying the electrical drive with electrical energy or to provide electrical energy. Due to this measure, when multiple load units are combined into a concatenation, the electrical energy may be transferred between the coupled load units of the concatenation, for example to ensure an effective electric driving of all load units in the concatenation until a transport destination has been reached. This measure facilitates a balancing or bidirectional charging (shifting of the energy in both directions) in order to change charge states of the batteries of the particular load units of the concatenation.

If necessary, the load unit may also be operated at higher speeds if the wheels and the electric drive are configured for a slow travel and for a fast travel. The chassis and the electrical components may thus have sufficient reserves and a corresponding stability for permitted maximum speeds of trucks, for example 80 km/h or 90 km/h.

A concatenation can be provided, which has at least two load units. The concatenation may be designed as a combination or so-called platoon. The load units preferably form a concatenation, in that they are connected to each other at interfaces. The connection to the interfaces may take place at least mechanically. The interconnected load units may be at least partially loaded with cargoes and be moved together. Since each load unit has an electric drive and a battery, the driving of the concatenation and the weight of the cargoes may be evenly distributed to a multiplicity of wheels.

In addition, the heaviness of the train or the concatenation and the necessary energy for operation in relation to the route, destination, and cargo may be optimized by distributing the cargo to multiple load units. The particular load units of the concatenation may be driven together for accelerating and for braking the concatenation. Depending on the design, the driving of the concatenation may be carried out by one load unit or a group of multiple load units from the totality of the load units in the concatenation.

The at least two load units can each be mechanically and electrically connected to each other via at least one interface, mechanical forces and/or electrical energy and/or data being transferable between the at least two load units via the connected interfaces of the load units. This measure permits a “sharing” of the electrical energy in the batteries of all load units of the concatenation to ensure a continuous driving of all load units.

The concatenation of multiple load units may be equipped for an autonomous operation, independently of territory, if at least one load unit has a sensor module. The sensor module may be mounted on an end face or front side of one of the load units and be electrically coupled to the load unit. The sensor module advantageously includes at least one control unit and a sensor system for the automated control of the load unit and/or the concatenation. The control unit and the sensor system are configured to autonomously control the concatenation of load units during fast travel. Due to this measure, the need for cost-intensive technology for autonomous driving outside logistics facilities is minimized, so that only one load unit out of multiple load units of the concatenation is provided with the replaceable sensor module. The sensor module may be connected to a centralized point, for example a cloud, to implement a centralized cloud routing from a logistics center.

Due to the sensor module, a data transfer to the central point may be set up in addition to a complex surroundings sensor system and a control adapted accordingly to the surroundings. For example, location data, traffic data, container data, charge state of the batteries of the concatenation, and the like may be ascertained with the aid of the connected interfaces and sent to the central point.

The sensor module can be arranged in the front area of a first load unit in the direction of travel and has a shape for reducing an aerodynamic drag of the load unit and/or the concatenation. The sensor module may perform a further function and optimize the aerodynamics of the concatenation.

A method for operating load units is provided. In a step, at least one load unit is loaded with at least one cargo. The loaded load unit is autonomously guided to a concatenation and/or at least one individual load unit during a slow travel and coupled to the concatenation and/or the individual load unit via the interface. During the coupling of the load unit to the concatenation, the coupling advantageously also takes place between two load units, a first load unit already having an existing first connection via an interface and subsequently entering into a second connection with a further load unit. The method facilitates the autonomous organization and sorting of the load units, depending on the loaded cargo and the transport destination of the cargo. Due to the autonomous control during a slow travel, these tasks may be implemented with the aid of a cost-efficient sensor system and controller, which is limited to the slow travel.

The slow travel may be limited to certain areas, such as logistics facilities, parking lots, truck stops, reloading points, and the like.

The load units of a concatenation can be autonomously sorted in their sequence within the concatenation within areas where slow travel is permitted. The load units of a concatenation may be sorted and regrouped hereby in certain intermediate stations along the way to the transport destination. Each cargo may have a separate transport destination. The load units may thus regularly form new concatenations or platoon trains and facilitate a fast and efficient transport of the cargoes.

Depending on the transport destination of the cargoes, the sequence of the load units within a concatenation may be adapted when the load units of at least two concatenations are autonomously sorted between the concatenations within areas with a permitted slow travel. The last load unit of a concatenation may thus always be decoupled upon reaching a transport destination. The entire concatenation may be retained by this measure up until the final transport or the final distribution of all cargoes.

Electrical energy can be divided between the batteries of the particular load units via interfaces during a slow travel or during a fast travel. The electrical energy of the batteries may be distributed hereby during the travel of the concatenation to prevent individual load units from not receiving a sufficient battery charge or not having battery capacity for finalizing the transport.

In particular, the energy may be distributed between the batteries of the particular load units such that, after one load unit is decoupled from the concatenation, sufficient battery capacity remains to unload the cargo and to reach a charging device.

The sensor module may permit a particularly precise control of the concatenation if the data ascertained by the sensor system of the particular load units are provided to the control unit of the sensor module and are processed thereby. The data analysis of the sensor module, in particular, may be optimized by receiving measurement data from a multiplicity of sensors of the particular load units.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic representation for illustrating a structure of a load unit according to an example;

FIG. 2 shows a perspective representation of a concatenation made up of multiple load units according to an example; and

FIG. 3 shows a schematic representation of multiple concatenations for illustrating a method for operating load units according to an example.

### DETAILED DESCRIPTION

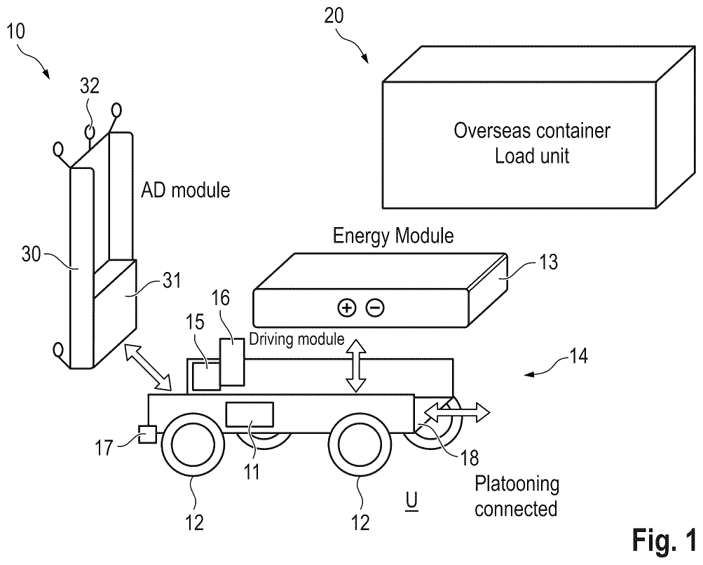

FIG. 1 shows a schematic representation for illustrating a structure of a load unit 10 according to an example. Load unit 10 is configured to receive at least one cargo 20 and to transport it on a drivable surface U.

In the illustrated example, cargo 20 is designed as a container. The drivable surface may be, for example, a paved or unpaved road, a loading yard on a highway, a port facility, or a logistics facility.

Load unit 10 comprises at least one electric drive 11 for driving wheels 12 of load unit 10 and at least one battery 13 for providing electrical energy for drive 11. Drive 11 is designed, for example, as at least one electric motor and is installed together with battery 13 in a platform or a chassis 14. Battery 13 may be designed to be replaceable on chassis 14.

The load unit includes at least one control unit 15 having a sensor system 16 for the automated control of load unit 10 during a slow travel.

Cargo 20 may be automatically or manually positioned on load unit 10 or removed therefrom in interaction with a container lifting system. Due to control unit 15 and sensor system 16, load unit 10 may be autonomously controlled in corresponding spaces or areas which do not have free access to the usual road users, despite reduced sensor system 16. Sensor system 16 may include, for example, radar sensors, lidar sensors, ultrasonic sensors, camera sensors, and the like.

A sensor module 30 may be fastened to load unit 10 on the front side. Sensor module 30 may be electrically and mechanically coupled to load unit 10. In the illustrated example, sensor module 30 acts as a windshield to improve the aerodynamics of load unit 10.

Sensor module 30 is provided with a control unit 31 and a sensor system 32, which permit an autonomous control of load unit 10 even during a fast travel. Sensor system 32 may have a greater range and precision than sensor system 16 of load unit 10. Control unit 31 of sensor module 30 may have a higher computing capacity than control unit 15 of the load unit. Due to the electrical coupling between sensor module 30 and load unit 10, the data of control unit 15 and sensor system 16 ascertained by load unit 10 may be received and evaluated by control unit 31 of sensor module 30 in addition to the measurement data of sensor system 32 on the module side.

Load unit 10 has, for example, two interfaces 17, 18 to facilitate a font-side and back-side coupling to other load units 10. Interfaces 17, 18 permit a mechanical and electrical coupling to facilitate a transfer of data and electrical energy in addition to a load distribution.

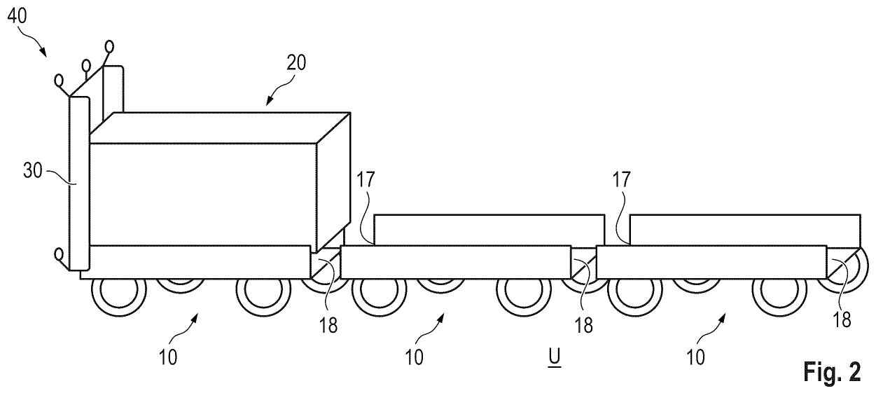

FIG. 2 shows a perspective representation of a concatenation 40 made up of multiple load units 10 according to an example. Concatenation 40 is designed as a platoon made up of multiple load units 10.

The load units form a concatenation in that they are connected to each other at interfaces 17, 18. The connection to corresponding interfaces 17, 18 takes place electrically and mechanically in the illustrated example.

Interconnected load units 10 may be at least partially loaded with cargoes 20 and be moved together. Since each of the load units has an electric drive 11 and a battery 13, drive 11 of concatenation 40 and the weight of cargoes 20 may be evenly distributed to a multiplicity of wheels 12.

First load unit 10 of concatenation 40 acts as a lead vehicle and is equipped with sensor module 30. Sensor module 30 may act as a so-called AD module (automated driving module) and facilitate the autonomous control of concatenation 40 without territorial restrictions.

Concatenation 40 may travel in a space having corresponding automatic container lifting systems, for example, in ports, to facilitate an automated coupling and decoupling of individual load units 10 at low speeds or during a slow travel. The slow travel may be, for example, 6 km/h and correspond to a walking speed. The slow travel may also take place at other speeds according to the legal requirements.

Load units 10 and/or concatenations 40 equipped with a sensor module 30 may also be operated at higher speeds, for example 80 km/h (maximum speed permitted for trucks on highways). The autonomous operation at a higher speed requires a more precise and more complex sensor system 32 having a higher computing capacity, which are provided in a targeted manner by sensor module 30 used in a modular manner.

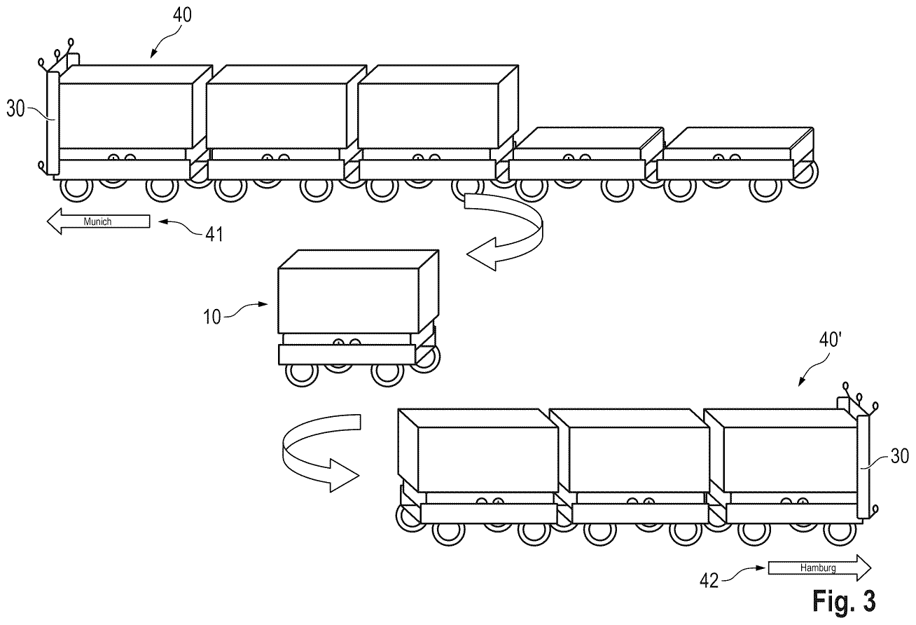

FIG. 3 shows a schematic representation of multiple concatenations 40, 40′ for illustrating a method for operating load units 10 according to an example. The method is also described with reference to FIG. 1 and FIG. 2.

In one step of the method, which is illustrated in FIG. 1, at least one load unit 10 is loaded with at least one cargo 20. Loaded load unit 10 is autonomously guided to a concatenation 40 and/or at least one individual load unit 10 during a slow travel and coupled to concatenation 40 and/or individual load unit 10 via interface 17, 18. In FIG. 2, for example, two load units 10 without cargo 20 are coupled to load unit 10 illustrated in FIG. 1, which has sensor module 30.

FIG. 3 illustrates an example of a traffic situation, in which a sorting of load units 10 between two concatenations 40, 40′ is carried out. The sequence of particular load units 10 within a concatenation 40, 40′ is changed, and one load unit 10 switches from a first concatenation 40 to a second concatenation 40′ in order to transport cargo 20 to a deviating transport destination 42.

For example, a first concatenation 40 having a first transport destination 41 and a second concatenation 40′ having a second transport destination 42 are illustrated. A sorting of load units 10 takes place at a reloading point. A load unit 10 is decoupled from first concatenation 40 and coupled to the back side of second concatenation 40′ This process may be carried out autonomously by load units 10 during a slow travel even without sensor modules 30.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A load unit, which is configured to receive at least one cargo and to transport it on a drivable surface, the load unit comprising:
at least one electric drive to drive wheels of the load unit;
at least one battery to provide electrical energy for the drive; and
at least one control unit having a sensor system for automated control of the load unit, the control unit and the sensor system being configured to autonomously control the load unit during a slow travel.

2. The load unit according to claim 1, wherein the load unit has a permanently installed or replaceable battery.

3. The load unit according to claim 1, wherein the load unit is configured to receive and transport a cargo in the form of a container and/or a crate and/or a receiving container having bulk materials and/or a container filled with fluids.

4. The load unit according to claim 1, wherein the load unit has at least one interface arranged on an end side in a direction of travel, the interface being configured to receive mechanical loads and to send and/or receive data.

5. The load unit according to claim 4, wherein the interface is configured to receive electrical energy or to provide electrical energy for charging the battery and/or for supplying the electrical drive with electrical energy.

6. The load unit according to claim 1, wherein the wheels and the electric drive are configured for a slow travel and for a fast travel.

7. A concatenation comprising:
at least two load units according to claim 1, the load units being connected to each other at interfaces.

8. The concatenation according to claim 7, wherein the at least two load units are each mechanically and electrically connected to each other via at least one interface, wherein mechanical forces and/or electrical energy and/or data are transferable between the at least two load units via the connected interfaces of the load units.

9. The concatenation according to claim 7, wherein at least one load unit includes a sensor module, the sensor module having at least one control unit and a sensor system for the automated control of the load unit and/or the concatenation, and wherein the control unit and the sensor system are configured to autonomously control the concatenation made up of load units during a fast travel.

10. The concatenation according to claim 9, wherein the sensor module is arranged in a front area of a first load unit in a direction of travel and has a shape for reducing an aerodynamic drag of the load unit and/or the concatenation.

11. A method for operating a load unit, the method comprising:
loading at least one load unit with at least one cargo; and
autonomously guiding the loaded load unit to a concatenation and/or to at least one load unit during a slow travel and coupling such via an interface.

12. The method according to claim 11, wherein the load units of a concatenation are sorted autonomously in their sequence within the concatenation in areas where slow travel is permitted.

13. The method according to claim 11, wherein the load units of at least two concatenations are sorted autonomously between the concatenations in areas where slow travel is permitted.

14. The method according to claim 11, wherein electrical energy is divided between batteries of the load units via interfaces during a slow travel or during a fast travel.

15. The method according to claim 11, wherein the data ascertained by the sensor system of the load units are provided to the control unit of the sensor module and processed thereby.
